(19) United States
(12) Patent Application Publication
(10) Pub. No.: US 2020/0012975 A1
(43) Pub. Date: Jan. 9, 2020

(54) ROUTE DETERMINATION

(71) Applicant: Polaris Consulting Limited, Farnborough (GB)

(72) Inventor: John Shimell, Farnborough (GB)

(21) Appl. No.: 16/503,765

(22) Filed: Jul. 5, 2019

(30) Foreign Application Priority Data
Jul. 5, 2018 (GB) 1811086.6

(51) Int. Cl. G06Q 10/04; G05D 1/00; G05D 1/02; G06K 9/00; G01C 21/34

(52) U.S. Cl. CPC G06Q 10/047; G05D 1/0088; G01C 21/343; G06K 9/00805; G01C 21/3484; G05D 1/0212

(57) ABSTRACT

A computer-implemented method of determining a route is provided. More specifically, provided is a method and apparatus for determining a route amongst obstacles and for recording the determined route. The methods and apparatus for determining a route may be uses for computerised navigation systems and autonomous vehicles.

This application claims the benefit of United Kingdom Patent Application No. 1811086.6, filed with the Intellectual Property Office of the United Kingdom on Jul. 5, 2018, the entire disclosure of which is incorporated by reference herein.

### FIELD OF THE DISCLOSURE

The present disclosure relates to a computer-implemented method of determining a route. In particular, but not exclusively, the disclosure relates to a method for determining a route amongst obstacles and for recording the determined route. The disclosure also extends to a corresponding apparatus.

### BACKGROUND TO THE DISCLOSURE

With the proliferation of computerised navigation systems and autonomous vehicles, there is an increasing demand for more effective methods of determining routes.

Many existing methods of determining routes rely on simple models of an environment through which a route must be found. For example, a model of a road network containing only the length and location of the roads in the road network allows a route to be determined according to these physical parameters. It may be possible to determine a route having the shortest distance through the road network using such a model, but this route may not necessarily be optimum. In order to provide a better optimised route, the model may take account of other information, such as road types, traffic models, time of day for the journey, the type of vehicle, a driver's preferences and driving style, fuel costs, current works on the road network, tolls and so on. However, this significantly increases computational complexity. Modelling air and marine environments is even more complex, due to the rapidly time varying nature of such environments, e.g. wind, tides etc., and the freedom to choose paths almost anywhere within these environments.

### SUMMARY OF THE DISCLOSURE

Aspects of the present disclosure are set out in the accompanying claims.

According to at least one aspect of the disclosure herein, there is described: a computer-implemented method of determining a route to a destination, the method comprising: initialising a plurality of agents, each of which agents is arranged to find a respective path towards the destination by making a series of route decisions based on behaviour parameters, the behaviour parameters being different for different agents; modifying the plurality of agents by: scoring the paths found by the plurality of agents, comparing the paths found by the plurality of agents to a threshold score, determining a first agent of the plurality of agents, the first agent having found a path with a score on one side of the threshold score, determining a second agent of the plurality of agents, the second agent having found a path with a score on the other side of the threshold score, adding a third agent to the plurality of agents, the third agent being arranged to find a path towards the destination based on behaviour parameters the same as the behaviour parameters of the first agent and initially being located on the path of the second agent, and optionally removing the first agent from the plurality of agents; and optionally repeating the modifying until the path found by at least one of the agents of the plurality of agents reaches the destination.

Preferably, the scoring is based upon at least one of: the time taken to travel along the path, risk associated with travelling along the path and cost of travelling along the path.

Preferably, the threshold score is based upon at least one of: a best scoring path; the relative scores of each path; a user-selected threshold score; a maximum allowable time; a maximum allowable risk; and a maximum allowable cost.

Optionally, the second agent is initially determined by at least one of: random selection among each agent having found a path with a score on the other side of the threshold score; selecting the agent related to a best scoring path; weighted random selection among the plurality of agents according to the relative scores of the path related to each agent.

Optionally, the location on the path of the second agent at which the third agent is initially located is dependent upon at least one of: the distribution of scores of the paths of one or more agents within the plurality of agents; the threshold score; a user selection; and a pseudorandom number.

Optionally, comparing the paths found by the plurality of agents to a threshold score comprises: comparing the paths found by the plurality of agents to a plurality of threshold scores; and determining a first agent of the plurality of agents having found a path with a score on one side of every score threshold.

Optionally, repeating the modifying until the path found by at least one of the agents of the plurality of agents reaches the destination comprises repetitively modifying the plurality of agents until a plurality of agents reaches the destination, preferably wherein the size of the plurality of agents is dependent upon the relative scores of at least two agents.

Optionally, the behaviour parameters of each agent are determined based upon a random seed.

According to another aspect of the disclosure, there is described: a computer-implemented method of determining a route to a destination, the method comprising: initialising a plurality of agents; which plurality of agents are each arranged to find a respective path towards the destination by making a series of decisions based on behaviour parameters, the behaviour parameters being different for different agents; wherein the behaviour parameters of each agent are determined based upon a random seed; storing the random seed associated with each agent.

Preferably the method further comprises recording a determined route based solely upon the random seed.

Preferably, the random seed is generated based upon a user selection.

Optionally, the behaviour parameters of each agent are determined based upon a plurality of random seeds.

Optionally, the behaviour parameters of each agent relate to at least one of: a frequency of changing direction; a probability of turning in a given direction; a probability of turning towards the destination.

Optionally, the behaviour parameters are determined using a probability density function, preferably a Gaussian distribution.

Optionally the behaviour parameters are determined based upon a user input, preferably the user input is at least one of: a capability range, a capability threshold, a preferred behaviour.

Optionally, the method further comprises: scoring the paths determined by each agent; comparing the paths found by each of the plurality of agents to a threshold score; and recording a feature of the paths scoring on one side of the threshold;

wherein the plurality of agents are each arranged to find a respective path towards the destination by making a series of route decisions based on recorded features related to the paths of prior initialised agents.

According to yet another aspect of the present disclosure, there is described a computer-implemented method of determining a route to a destination, the method comprising: repetitively initialising a plurality of agents, which plurality of agents are each arranged to find a respective path towards the destination by making a series of route decisions based on behaviour parameters, the behaviour parameters being different for different agents; scoring the paths determined by each agent; comparing the paths found by each of the plurality of agents to a threshold score; and recording a feature of the paths scoring on one side of the threshold; wherein the plurality of agents are each arranged to find a respective path towards the destination by making a series of route decisions based on recorded features related to the paths of prior initialised agents; optionally, wherein the agents are repetitively initialised until at least one of the agent reaches the destination.

Preferably, the recorded feature is a heading.

Optionally, the recorded feature is a summed vector of the recorded feature of a plurality of paths scoring above the threshold score. Preferably, the summed vector is weighted based upon the relative scores of the plurality of paths.

Optionally, the recorded feature is recorded for a predetermined number of reinitialisations. Optionally, the recorded feature is not altered between generations. Optionally the predetermined number of reinitialisations depends on the score of the related path.

Optionally the method further comprises recording a feature of the paths scoring on the other side of the threshold.

Preferably, the area over which the plurality of agents is affected by the recorded feature changes between generations. Preferably, the change is an increase. Optionally, the effect of the recorded feature decreases as the area affected increases.

Optionally, the agents are arranged to determine a route between two locations in an environment; wherein the environment comprises a plurality layers, each layer relating to a different feature.

According to yet another aspect of the present disclosure, there is described initialising a plurality of agents; wherein the agents are arranged to determine a route between two locations in an environment; wherein the environment comprises a plurality layers, each layer relating to a different feature.

Preferably, the layers include at least one of: an agent layer, a static obstacle layer; a dynamic obstacle layer, a natural conditions layer, a user input layer, a bathymetry layer and/or wherein at least one layer relates to at least one of: a frequency of data being updated; a data source; and a measure of the reliability of data.

Optionally, the layers are of different sizes.

According to yet another aspect of the present disclosure, there is described a computer-implemented method for determining a route to a destination, the method comprising: determining a route using the method of any one of the preceding claims; determining an improvement related to modifying a portion of the determined route; modifying a portion of the determined route using the method of any one of the preceding claims.

Preferably, the method comprises determining waypoints within the determined route; wherein modifying a portion of the determined route comprises modifying a portion of the determined route between two waypoints.

According to yet another aspect of the disclosure herein, there is described an apparatus arranged to carry out the method of any one of the preceding claims, preferably wherein the apparatus comprises an interface for obtaining environmental data, more preferably wherein the interface for obtaining environmental data is at least one of: a sensor arranged to detect obstacles; a communications interface.

The disclosure extends to a vehicle incorporating a device as aforesaid.

The disclosure further extends to a system comprising a device as aforesaid, a memory for storing information, a means for outputting output data, and means for receiving input data.

The disclosure yet further extends to a system for controlling a vehicle, comprising a device as aforesaid, further comprising means for receiving an output from the device; and means for providing an actuation signal for controlling the vehicle in dependence on the output from the device.

The disclosure yet further extends to a vehicle incorporating the system as aforesaid.

According to another aspect of the disclosure, there is provided computer software for carrying out any of the methods described above.

The disclosure extends to any novel aspects or features described and/or illustrated herein. Further features of the disclosure are characterised by the other independent and dependent claims.

Any feature in one aspect of the disclosure may be applied to other aspects of the disclosure, in any appropriate combination. In particular, method aspects may be applied to apparatus aspects, and vice versa.

Furthermore, features implemented in hardware may be implemented in software, and vice versa. Any reference to software and hardware feature herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform and of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

The disclosure extends to methods and/or apparatus substantially as herein described with reference to the accompanying drawings.

The present disclosure may relate to a tool (e.g. a method) implemented on a device that permits the automatic determination of routes via the production of timed waypoints. The automatic determination of routes allows vehicles (such as

Unmanned Surface Vehicles or USVs) and other vehicles or agents to navigate from one user-defined location to another. The device for determining routes can also be used as an obstacle avoidance tool that uses the positions of other obstacles (e.g. vehicles) whilst running and directs the vehicle accordingly.

Preferred embodiments are described below, by way of example only, with reference to the accompanying drawings.

### BRIEF DESCRIPTION OF THE DRAWINGS

FIG. 1 shows a system comprising two locations;

FIG. 2 is an illustration of a generic computer device on which different elements of a navigation apparatus are implemented;

FIG. 3 is an illustration of a system for implementing a route determining method;

FIG. 4 is a component view of the system;

FIG. 5 is a flowchart of a method of determining a route between locations;

FIG. 6 is a flowchart of an aspect of a method of determining a route between locations;

FIG. 7 is a flowchart of another aspect of a method of determining a route between locations;

FIG. 8(a) shows a method of reinitialising an agent;

FIG. 8(b) shows a method of reinitialising an agent;

FIG. 8(c) shows a method of reinitialising an agent;

FIGS. 9 shows a route determined by a reinitialised agent;

FIG. 10 shows a layer-based depiction of an area;

FIG. 11(a) shows an aspect of a method of recording previously determined routes;

FIG. 11(b) shows an aspect of a method of recording previously determined routes;

FIG. 12 shows a further view illustrating the implementation of the aspect of a method shown in FIG. 11(a) or 11(b);

FIG. 13 shows a method of entering simulation data;

FIGS. 14(a) shows routes determined by a route finding method dependent upon differing metrics;

FIG. 14(b) shows routes determined by a route finding method dependent upon differing metrics;

FIG. 14(c) shows a route determined by a route finding method dependent upon differing metrics;

FIG. 15 shows a method of determining deviations from routes determined by the route finding method;

FIG. 16(a) is a flowchart of a detailed aspect of a method of finding a route between locations;

FIG. 16(b) is a continuation of FIG. 16(a); and

FIG. 17 shows various uses for a route finding method.

### DETAILED DESCRIPTION OF THE PREFERRED EMBODIMENTS

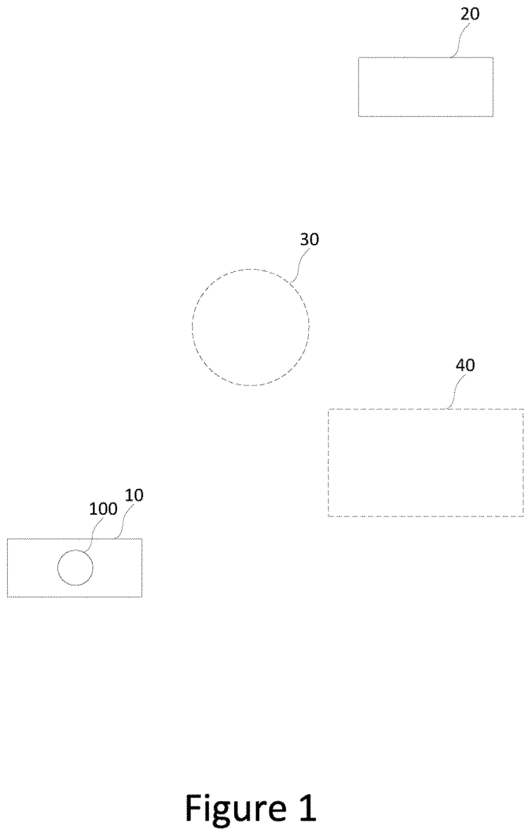

Referring to FIG. 1, in a typical scenario, it is desired to determine a route for an object 100 through an environment 1 from a starting point 10 to a destination 20. The environment 1 includes an obstacle 30 and an undesirable zone 40.

The object 100 is usually a vehicle. In the illustrated embodiment, the object 100 is a vessel, e.g. a boat or ship, and the environment 1 is a marine environment, e.g. tidal waters. However, this scenario is just one possibility and is certainly not essential. In other embodiments, the object 100 is another type of vehicle, such as land vehicle in the form of a car, van, truck, or an aircraft such as an airborne drone. In some embodiments the vehicle is driven, helmed or piloted by a human. In other embodiments the vehicle is autonomous. It is also possible that the object 100 is a navigation device, which navigation device is carried in a vehicle or by a human. Indeed, in some senses the object may be a human or animal themselves.

It is intended for the object 100 to start at the starting point 10 and to travel though the environment to the destination 20. As the object 100 travels through the environment 1 it may encounter the obstacle 40 and/or the undesirable zone 40.

The obstacle 30 affects the progress of the object 100, e.g. by slowing the object 100 or blocking progress of the object 100 through the environment 1. In the context of a marine environment, the obstacle 30 is usually an unnavigable area, such as land, rocks or shallows, or another vessel.

The undesirable zone 40 comprises an area or volume within the environment 1 through which the object is able to pass, but which it is usually preferable to avoid. For example, the object 100 may experience a negative impact by passing through the undesirable zone 40, e.g. increased danger or slower passage. In the context of a marine environment, the undesirable zone 40 may be an area of adverse current or tide, adverse weather, a shallow yet navigable water, an area of proximity to another vessel, or an area of greater marine traffic.

In some embodiments, there is additionally or alternatively a desirable zone (not illustrated), which is an area or volume of the environment that has a positive impact upon the object 100 if the object 100 passes through that zone. In the context of a marine environment, the desirable zone may be an area of favourable current or tide, favourable weather or an area of less marine traffic.

The present disclosure relates to a method of determining a route for the object 100 from the starting point 10 to the destination 20. In the illustrated embodiment, the method is carried out remotely from the object 100. That is, an apparatus for determining a route for the object 100 is provided located remote from the object 100. In one implementation, the apparatus comprises computer processing means in the form of a server. The object 100 is arranged to communicate with the server, such that the server can receive data for use in determining the route from the object 100 and transmit send data representing the route to the object. However, this is not essential, and in other embodiments the apparatus is provided as part of the object 100, e.g. as computer processing means in the form of a navigation device. In a particular implementation, the navigation device may be installed on the vessel.

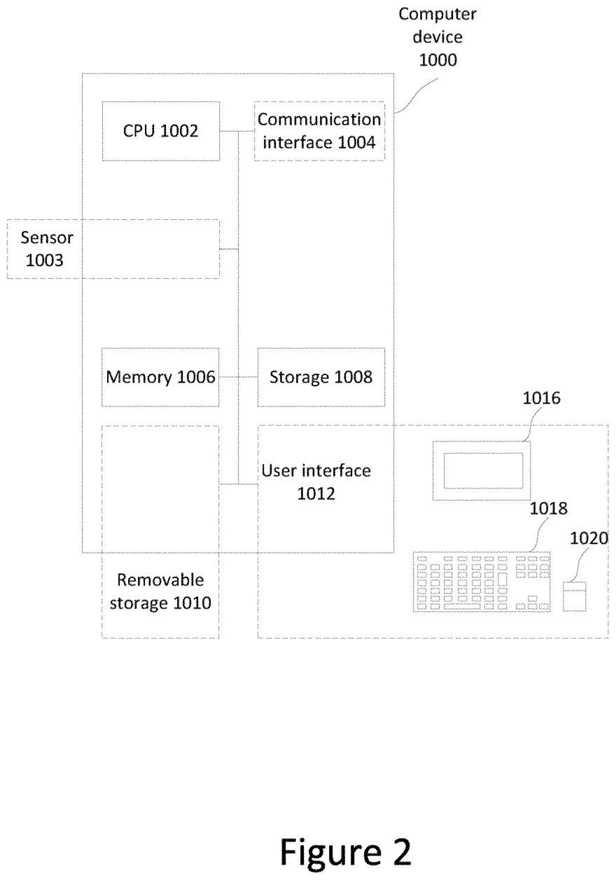

Referring to FIG. 2, the route finding apparatus is implemented on a computer device 1000. The computer device 1000 comprises a processor in the form of a CPU 1002, a communication interface 1004, a memory 1006, storage 1008, removable storage 1010 and a user interface 1012 coupled to one another by a bus 1014. The user interface 1012 comprises a display 1016 and an input/output device, which in this embodiment is a keyboard 1018 and a mouse 1020. In other embodiments, the input/output device comprises a touchscreen.

The CPU 1002 executes instructions, including instructions stored in the memory 1006, the storage 1008 and/or removable storage 1010.

The memory 1006 stores instructions and other information for use by the CPU 1002. The memory 1006 is the main memory of the computer device 1000. It usually comprises both Random Access Memory (RAM) and Read Only Memory (ROM).

The storage 1008 provides mass storage for the computer device 1000. In different implementations, the storage 1008 is an integral storage device in the form of a hard disk device, a flash memory or some other similar solid state memory device, or an array of such devices.

The removable storage 1010 provides auxiliary storage for the computer device 1000. In different implementations, the removable storage 1010 is a storage medium for a removable storage device, such as an optical disk, for example a Digital Versatile Disk (DVD), a portable flash drive or some other similar portable solid state memory device, or an array of such devices. In other embodiments, the removable storage 1010 is remote from the computer device 1000, and comprises a network storage device or a cloud-based storage device.

A computer program product is provided that includes instructions for carrying out aspects of the method(s) described below. The computer program product is stored, at different stages, in any one of the memory 1006, storage device 1008 and removable storage 1010. The storage of the computer program product is non-transitory, except when instructions included in the computer program product are being executed by the CPU 1002, in which case the instructions are sometimes stored temporarily in the CPU 1002 or memory 1006. It should also be noted that the removable storage 1008 is removable from the computer device 1000, such that the computer program product is held separately from the computer device 1000 from time to time.

The communication interface 1004 is typically an Ethernet network adaptor coupling the bus 1014 to an Ethernet socket. The Ethernet socket is coupled to a network.

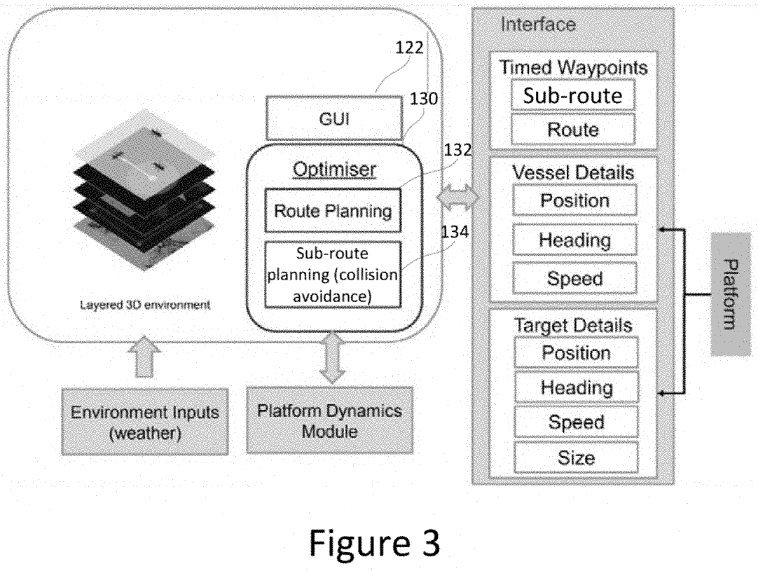

Referring to FIG. 3, it is useful to illustrate functional modules of an apparatus, which is useable to determine a route. It will be appreciated that the illustrated modules are implemented as computer software running on the computer device 1000 and, as such, are not necessarily physically distinct from one another.

The apparatus comprises a Graphical User Interface (GUI) 122 and an optimiser 130. The optimiser 130 comprises a route planning module 132 and a sub-route planning module 134.

The route planning module 132 is arranged to determine a route between the starting point 10 and the destination 20. The route planning module 132 also provides data representing the route to the object 100. In some embodiments, this may involve displaying the route on the display 1016 of the user interface 1012 or communicating the data representing the route directly to an autopilot of the object. However, in the illustrated embodiment, it involves transmitting the data representing the route to the object 100 via the communication interface 1004.

The sub-route planning module 134 is arranged to periodically determine sub-routes within the determined route and/or to determine deviations to the initially determined route. These sub-routes are used to modify portions of the determined route and are determined using methods equivalent to those for determining routes.

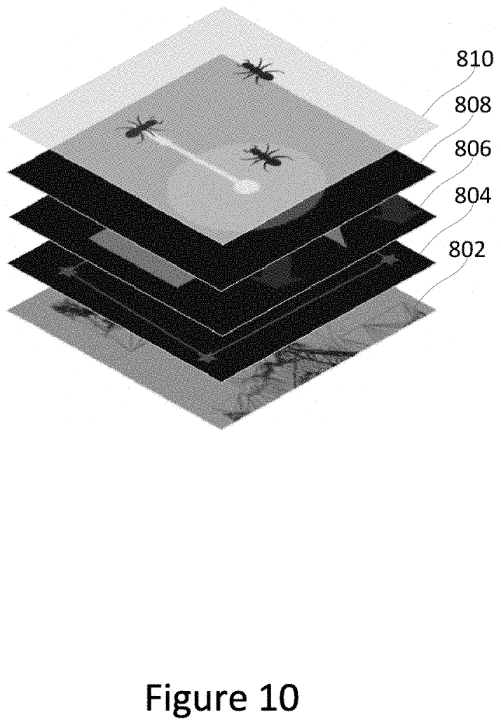

The apparatus is arranged to obtain object data relating to the object 100 and environment data relating to the environment 1 via communication interface 1004. Environment data is also obtained from the memory of the apparatus, e.g. the storage 1008 of the computer device 1000 on which the apparatus is implemented. The object data and environment data is interpreted in the form of a layered environment. This is illustrated as part of the apparatus in FIG. 3 and described in more detail below with reference to FIG. 10.

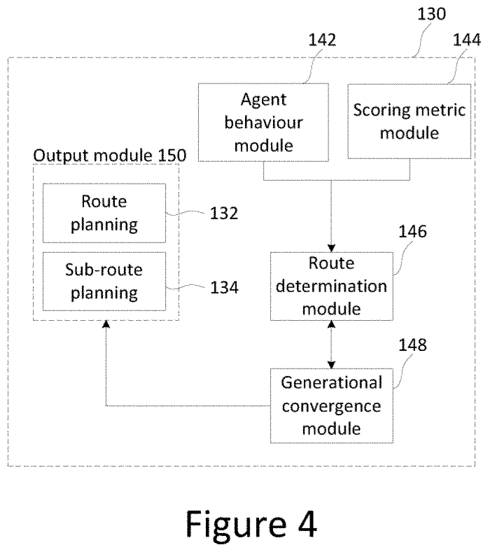

Referring to FIG. 4, there is shown a component model of the optimiser 130.

The optimiser comprises an agent behaviour module 142, a scoring metric module 144, a route determination module 146, a generational convergence module 148, and an output module 150. The output module comprises the route planning module 132, and the sub-route planning module 134.

The agent behaviour module 142 is arranged to set the behaviour of the agents used within the determination of a route. In this embodiment, agents are initialised using a random seed which determines the properties and behaviour of the agents. The agent behaviour module 142 generates this random seed. The agent behaviour module 142 is arranged to transmit these properties to the route generation module 146.

The scoring metric module 144 is arranged to determine the scoring metric to be used within the determination of a route based upon the preferences of a user implementing the route finding method. The scoring metric module 144 is arranged to transmit this metric to the route generation module 146.

The route determination module 146 is arranged to determine a route for a generation. The route determination module 146 is arranged to communicate with the generational convergence module 148.

The generational convergence module 148 is arranged to determine when the routes have sufficiently converged. The generational convergence module 148 is arranged to communicate with the route determination module 146 to receive the routes required to determine this. The generational convergence module 148 is arranged to transmit a converged route(s) to the output module 150.

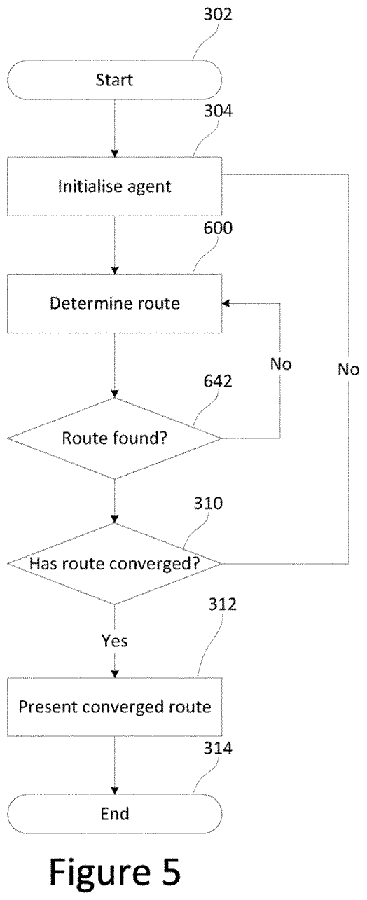

Referring to FIG. 5, a route finding method is implemented on the computer device 1000.

In a first step 302, a route finding method is started. In this embodiment, this occurs when a user enters a start command into the input/output device. In other embodiments, the starting of the route finding method occurs upon a starting condition being met, such as an obstacle being detected or location information being received.

In a second step 304, an agent is initialised using the agent behaviour module 142. The agent is a computer generated object that is arranged to determine a possible route between the starting point 10 and the destination 20. In this embodiment, this is achieved by the agent starting at the starting point 10 at a start time t₀=0. This time is incremented, and with each increment the agent moves by an amount that depends upon the velocity associated with the agent and the length of the time step as well as any modifiers applied due to passage through, for example, the undesirable zone 40. In this way the agent eventually reaches the destination 20.

The agent moves according to a number of defined properties. The properties may include, but are not limited to: a preferred speed; an amount of time until a directional change is performed; a probability of turning in any given direction, a probability of turning towards the destination 20; a reaction to, or range of possible reactions to, encountering an obstacle, where this may be a range of actions alongside a probability of performing each action; and a probability of following a previously selected path (the probability of following a previously selected route is described in more detail later). As relates to any change in the movement of an agent, for example due to an obstacle or a previously selected route, the agent may: slow down, speed up, change direction, change orientation, and/or maintain the same speed and course.

In some embodiments, there are environmental factors that might prevent the agent from reaching the second location, for example in some embodiments the obstacle 30 is arranged to stop permanently any agent that it comes into contact with. In these embodiments, there may a threshold time after which the route determination process is stopped. Any agents that have not formed a route to the destination may be discounted, or have a score penalty applied.

In a third step 600, a route is determined using the route determination module 146. This route is the complete path by which the agent has moved from the starting point 10 to the destination 20.

In a fourth step 642, it is identified whether a route has been found. Route determination proceeds until a route has been found. In this embodiment, this comprises incrementing a time step, where the agent continues to move with each time step until a check determines that the agent has reached the destination 20.

In a fifth step 310, it is checked whether the route has converged on the generational convergence module 148. The above process of determining a route is repeated (for a number of generations) until the agent has selected a sufficiently similar route in a number of generations. Convergence of the route occurs due to the reinitialisation of agents and/or the dependence of agent behaviour upon previously generated routes. These features are explained in detail below.

In this embodiment, a plurality of agents are initialised, each of which determines a route. Convergence then also refers to the number of agents determining the same route, where the requirement of determining a sufficiently similar route refers to determining a similar route in a number of generations and also to a number of agents determining similar routes.

The degree of similarity which is sufficient and the required number of sufficiently similar attempts varies in various embodiments. This is, in some embodiments, determined by a user.

In a sixth step 312, after the route is determined to have converged, this converged route is presented to the user using the route planning module 132. In some embodiments, the user comprises a person and presenting the converged route comprises displaying the converged route to the person. In some embodiments, the user comprises a navigation device, such as a computer or a propulsion device. In some of these embodiments, the presentation of the converged route is a command to a navigation device to travel along the converged route.

In a seventh step 314, the method ends.

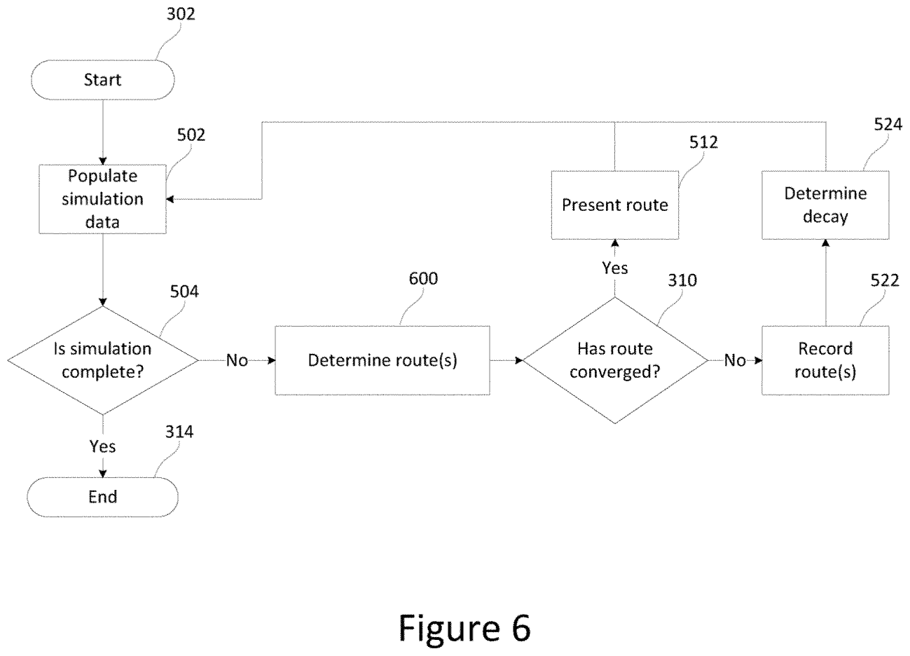

Referring to FIG. 6, the route finding method of FIG. 5 is described in more detail.

As before, in a first step 302, a route finding method is started.

In a second step 502, simulation data is populated. This uses both the agent behaviour module 142 and the scoring metric module 144. This refers to the obtaining of data required for the route finding method to progress.

As examples, this data may refer to:
location data, such as GPS coordinates of the starting point 10, the destination 20, and/or a wider area of interest containing these locations.
environmental data, such as weather related data, which could be forecast data, and/or tidal data;
obstacle data, such as data defining the size, position, and/or movement properties of the obstacle(s) 30;
area data, such as data referring to the undesirable zone 40 and/or any desirable zones. This may, for example, comprise data related to the boundaries of the undesirable zone 40 or a measure of the penalty incurred for travelling through the undesirable zone 40;
agent data, such as data which defines the properties and/or behaviour of the agents used within the route finding method as well as the number of agents used;
scoring data, such as an indication of which properties of a route should be prioritised. This may, for example, indicate that speed is more important than cost.

In a third step 504, it is determined whether the simulation is complete. In general, the simulation is complete when a converged route has been found by the generational convergence module 148 and presented using the route planning module 132 or the sub-route planning module 134.

In a fourth step 600, routes are determined using the route determination module 146. Routes are determined according to properties of the agents. More specifically, the behaviour of each agent, which is determined by that agent, varies according to the simulation data—for example, each agent may react differently to the obstacle 30.

In some embodiments, a single route is returned in this step, where this route is the highest scoring route of the generation. In other embodiments, a plurality of routes are returned. This plurality may comprise a combination of high and/or low scoring routes, or may include all routes.

In a fifth step 310, it is determined whether the route has converged. As described with reference to FIG. 4, this convergence is dependent upon sufficiently similar routes being determined a number of times in a row.

More specifically, in some embodiments, the number of similar generations required, and the required similarity of the routes are selected by the user. In other embodiments, these properties are selected dependent upon the simulation data obtained in the second step 502. In yet more embodiments, the properties are predetermined. In this embodiment, these properties are dependent upon properties of the simulation, such as convergence speed. If the route converges rapidly a greater similarity is required for sufficiency. Similarly, if a number of routes within a generation are very similar, the number of similar generations required is reduced.

If the route has not converged, in a sixth step 522 the route(s) of at least one agent is recorded. This recorded route is used by agents within subsequent generations as is described below.

In a seventh step 524, following the sixth step 522, the decay of the recorded route is determined. The recorded route affects the agents for a finite number of generations, each generation the route decays, where the number of remaining generations is reduced.

In an alternate sixth step 512, if the route has converged, the converged route is presented using the route planning module 132.

The method then returns to the second step 502, where simulation data is populated. This process updates the data required for the route finding method so that, for example, weather conditions, or the position of the obstacle 30, are up to date. This step is, optionally, skipped if the route is found to have converged in the fifth step 310.

After the repeated second step 502, the third step 504, is repeated, where it is checked whether the simulation is complete 504. As above, the simulation is, in general, complete when a converged route has been found and presented. In some embodiments, the simulation proceeds even once a converged route has been presented. The route finding method runs periodically or continuously until halted by a user or a halting condition, such as reaching the destination 20. In this way, updated converged routes, e.g. sub-routes, are determined that react to changes in information received during a journey.

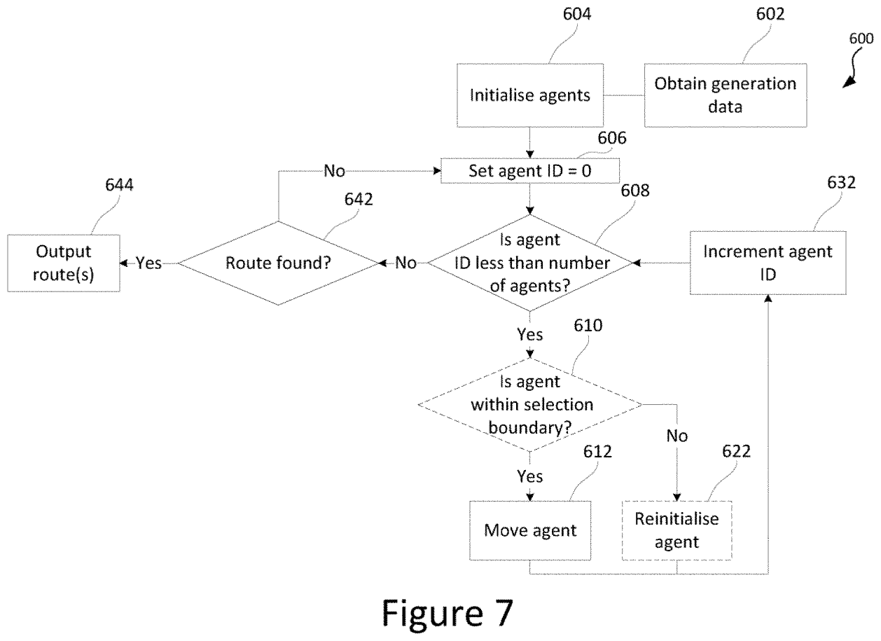

Referring to FIG. 7, a preferred method for the determination of a route is described.

In a first step 602, generation data is obtained. This generation data comprises the data required to find a route for a single generation and concerns, in many embodiments, similar information as the simulation data referred to with reference to FIG. 6. In this embodiment, the generation data is a subset of the simulation data. More generally, the generation behaviour contains the information about the environment and agents required to determine a route. The generation data also, optionally, contains data about recorded routes from previous generations.

In a second step 604, the agents are initialised. This refers to the properties of each agent being set. In this embodiment, the number of agents used is set by a user. In other embodiments, the number of agents used is determined based upon a feature of the simulation—such as the size of the environment considered.

In a third step 606, the agent ID is set to equal zero. The agent ID is a variable used by the computer device 1000 to identify an agent to be analysed.

In a fourth step 608, it is checked whether the agent ID is less than the number of agents; this step is used to ensure that at each period of analysis, in this embodiment after each time step, each agent has been considered.

If each agent has not yet been considered, in an optional fifth step 610, which is described in further detail with reference to following figures, it is determined whether the considered agent is within a selection boundary. The selection boundary is determined based upon a determined minimum score.

Each agent determines a path, where these paths can be scored in order to rank the paths and determine the best paths within the current generation of agents. In this embodiment, a selection boundary is determined periodically which determines which agents are below a threshold probability of determining the best path for the current generation.

The path, once complete, e.g. once it links the starting point 10 and the destination 20, comprises a route between the locations.

In a sixth step 612, agents within the selection boundary are moved. In this embodiment, this comprises determining the amount of movement within the considered time step to determine a next location of the agent. In embodiments which do not consider a selection boundary, each agent is moved.

In some embodiments, at this point it is also checked whether any agents have reached the second location. There is, in this embodiment, an initial analysis of each agent performed (not shown in FIG. 7), which performs this location check (for whether any agents have reached the second location). This initial analysis optionally also considers the current score of each agent, to enable determination of a suitable selection boundary.

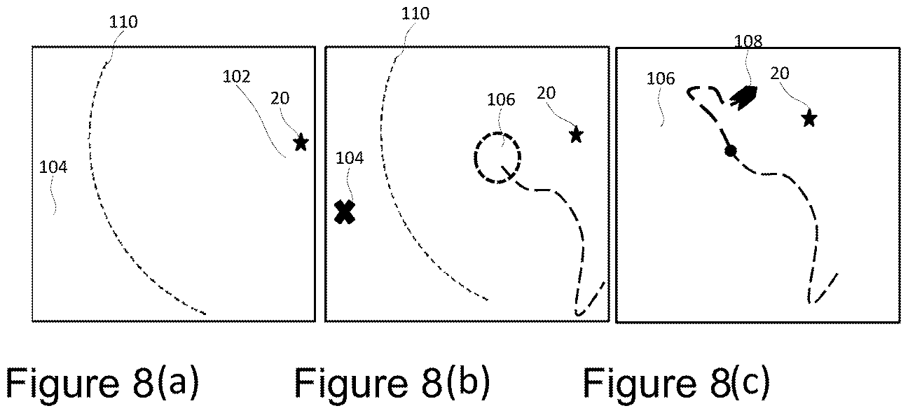

In an alternate sixth step 622, agents not in the selection boundary are reinitialised. This process is explained with reference to FIGS. 8(a)-8(c) below.

In a seventh step 632, the agent ID is incremented so that the performance of the next agent is considered.

When each agent has been considered, in an eighth step 642, it is determined whether a route has been found between the starting point 10 and the destination 20. In some embodiments, a number of routes are required for this determination to be met, for example 5% or 10% of the agents are required to have found a route.

If a route has been found, in a ninth step 644, the route(s) is output. It is then determined whether the routes output for this generation comprise a converged route—this occurs with reference to the routes found in previous generations.

If, at the eighth step 642, a route has not been found, the method repeats from the third step 606, where the current performance of each agent is considered.

In this embodiment, the movement of agents occurs in relation to time, where each agent moves along a path at periodic timesteps. In other embodiments, the period of agent analysis (the third step 606 onwards) occurs after another condition is met, for example, in some embodiments the first time at which an agent reaches the destination 20, or a midway point, is determined. The selection boundary, and the locations and paths, of each other agent, is then considered at this point in time.

Referring to FIGS. 8(a)-8(c), the fifth step 610 and the alternative sixth step 622 of FIG. 7 are described in more detail.

Referring to FIG. 8(a), the locations of agents, represented as polygons, are shown at the point where a first agent 102 reaches the destination 20. A selection boundary 110, is determined based upon a determined score for at least one agent.

The score of each agent may be based upon, for example, the time for that agent taken to reach its current location, the time that would be needed to reach the destination 20, the risk penalty for travelling through the undesirable zone 40, and/or the fuel cost to reach the location.

The selection boundary 110 is preferably determined based upon a threshold possibility of another agent exceeding the determined score. In FIGS. 8(a)-8(c), the selection boundary 110 is strongly related to the distance to the destination 20, where agents outside this selection boundary 110 would not be able to reach the second location in an acceptable time. More generally, the selection boundary 110 may depend on any chosen metric, so that it may not be simply represented visually.

The selection boundary 110 is, in some embodiments, determined as a percentage score of the highest scoring agent at the time of the determination. This may be, but is not necessarily, the first agent 102. Although the first agent 102 has reached the destination 20 first, the scoring metric may prioritise other goals, such as a low cost, which may result in the first agent 102 not being the highest scoring agent.

The selection boundary 110 is, in some embodiments, determined as an, optionally weighted, average score for a number of the highest scoring agents. This enables a rapid assessment of scoring threshold.

The scoring is described here with relation to agents, equally scoring could be considered to related to the path selected by that agent, as each agent is related to a path. Any aspects relating to the score of agents could also be implemented as aspects relating to the score of paths and vice versa.

Referring to FIG. 8(b), a second agent 104 which is outside of the selection boundary 110 is identified. When it is determined that the second agent 104 is no longer able to obtain a score exceeding that of the first agent 102, this agent is no longer considered.

In some situations, an agent that performs poorly in determining a first portion of a route may perform optimally in determining a following portion of a route. As a simple example, an agent may have properties that result in it regularly changing direction. This agent would perform poorly when faced with a straight corridor between obstacles, however it might perform well when faced with a twisting corridor. An environment may comprise straight sections as well as twisting sections, so that, the behaviour of this agent would be desirable in only portions of this environment.

So that agents that may perform well in only sections of an environment are not discounted, agents outside of the selection boundary 110 are preferably reinitialised. A third agent 106 inside the selection boundary is determined and, referring to FIG. 8(a), a fourth agent 108 is initialised which has the behavioural properties of the second agent 104, but follows at least a portion of the path of the third agent 106. The fourth agent 108 is considered thereafter to be the second agent 104—and the previous path of the second agent is not recorded or considered after reinitialisation.

In this embodiment, the third agent 106 is determined randomly, for example using a random number generator. In other embodiments, the third agent 104 is determined as the highest scoring agent at the point of reinitialisation, this may be, but is not necessarily, the first agent 102. In yet other embodiments, the third agent is determined using a weighted random process, where weightings are determined based upon a feature of the agents or of the routes determined by the agents.

The portion of the path of the third agent 106 followed by the fourth agent 108 is, in this embodiment, determined by the location of the third agent 106 at the time when the selection boundary 110 is determined. More generally, any portion of this path may be considered.

This example considers the selection boundary 110 being determined at the point where an agent has reached the second location. In some embodiments, the selection boundary 110 is determined periodically, for example after each timestep. In these examples, agents are scored based on current paths where, for example, proximity to the destination 20 is considered within scoring. Agents outside of the selection boundary 110 are then reinitialised after each timestep.

The scoring metrics are selectable by the user of the method and optionally comprise: a risk score; a cost score, for example a fuel cost, a parts cost, or a cost of tolls; and a time score. Each score is weighted within the determination of an overall score. The scores are optionally normalised so that the differences between agents are easily determinable.

Within an overall score there are numerous component scores, such as a time score, a distance score, and a risk score. The selection boundary 110 may relate to component scores and/or an overall score, where there may be multiple selection boundaries. There may be a maximum time to reach the destination 20 alongside a maximum risk allowable, where these are considered within the selection boundary.

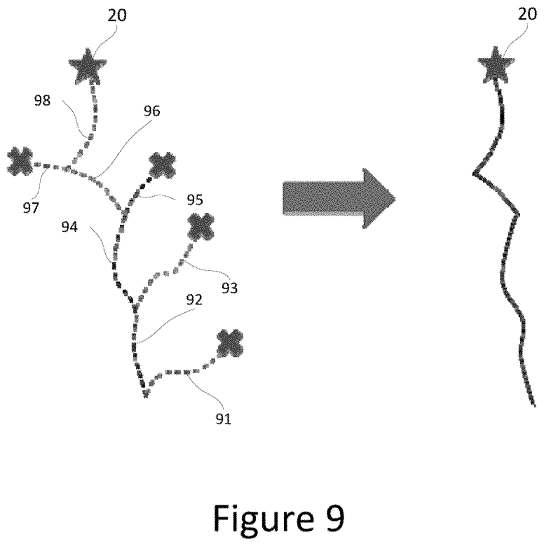

Referring to FIG. 9, a route determined by an agent that has been reinitialised multiple times is shown.

The separate component paths 91, 92, 93, 94, 95, 96, 97, and 98 of the determined route each correspond to the behaviour of different agents. In this way, the determined route takes into account the behaviours of different agents which are advantageous at different times.

In general terms, there is shown in FIG. 9, initialisation of a plurality of agents; wherein each agent exhibits different behaviours, as shown by, at least, the difference between the first component path 91 and the component second path 92; scoring of the path determined by each agent; determining a threshold score based upon the score of at least one path, as can be seen from the route; determining a first agent related to a path scoring below the score threshold, e.g. that related to the first component path 91; determining a second agent related to a path scoring above the score threshold, e.g. that related to the second component path 92; initialising a third agent; the third agent being arranged to exhibit the behaviour of the second agent during the determination of a first portion of a path, e.g. the third agent behaves as the second agent to follow the second component path 92; and wherein the third agent is arranged to exhibit the behaviour of the first agent during the determination of a second portion of a path, e.g. the third agent behaves as the first agent during the determination of a third component path 93.

As the agent is reinitialised repeatedly, it eventually exhibits the behaviour of numerous agents, in the example of FIG. 9, four different agent behaviours are exhibited. This is interpretable as two agent behaviours, the first behaviour being that exhibited for the first three portions 92, 94, 96 of the completed route, and the second behaviour being that exhibited for the final portion 98 of the completed route. This second behaviour is that of the first agent.

Referring to FIG. 10, a layer approach to considering simulation data is shown.

By inputting data into layers, the entry of data and the consideration of data by the agents is simplified. Data layers are preferably separated based upon a feature of the data.

In the example shown in FIG. 10, environmental data comprises:
a base layer 802, which contains information about the location in which a route is being planned. This contains, for example, data about the locations of land;
a second layer 804, which contains information about locations of interest, such as the starting point 10, the destination 20, and a boundary beyond which the agents cannot travel;
a third layer 806 containing climate and tidal information;
a fourth layer 808, containing information about obstacles; this layer also contains information about the movement properties of obstacles. In this embodiment, information about obstacles is obtained using the sensor 1003 of the computer device 1000, where obstacle information is updated dependent upon the period of sensor measurement being taken.
a fifth layer 810, containing information about agents.

In differing embodiments, more or less layers are used, where additional layers may be included and the layers described with reference to FIG. 10 may be combined or split further.

The agents, during determination of their path, are able to consider the properties of each layer either separately or in combination.

This approach enables data to be simply updated without reloading fixed data—which would incur an unnecessary computational cost. Data that is substantially unchanging, such as location data contained in the first layer 802, is obtained only at the start of the simulation. Changing data, such as the tidal data contained in the third layer 806, is updated periodically as appropriate, where tides may change significantly over the course of minutes or hours. Obstacle data, as is contained in the fourth layer 808, is updated more regularly, where the behaviour of obstacles may change on a timescale of the order of seconds. The updating period may depend upon the obstacle, for example, a rapidly moving obstacle may be updated more regularly than a slow moving obstacle. In some embodiments, layers are separated by the source of data and/or the updating period, where there may be, for example, multiple obstacle layers related to different sensors and to different update rates.

As well as being updated on different timescales, certain layers may be updated on the occurrence of an event. As an example, the obstacle layer may be updated if the a sensor detects a previously undetected obstacle, or if a sensor obtains more information about an obstacle.

The layers are not necessarily of a uniform size, either between or within layers. As examples, location data may be entered precisely in regions of interest and less precisely outside of these regions. Obstacle data may only be entered in the region where the obstacle may travel and include no data outside of that.

The agents, when considering the layers, preferably consider each layer with regard for the location data. As an example, if there is no obstacle data related to a location, it is assumed that there is no obstacle in that location. In this way, the amount of information that is recorded is minimised—data not being present for, for example, an obstacle, significant weather, or a shallow area is useable to imply that these conditions are not present without it being explicitly recorded within the data.

In some embodiments, a lack of information is also recorded, so that it may be recorded that it is not known whether an obstacle is present. The agents may modify their behaviour to account for this, e.g. they may behave more cautiously and/or only stay in desirable zones.

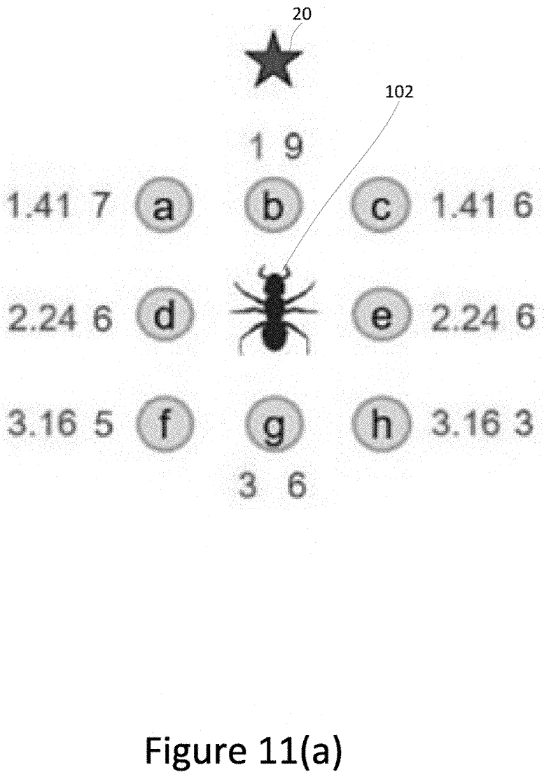

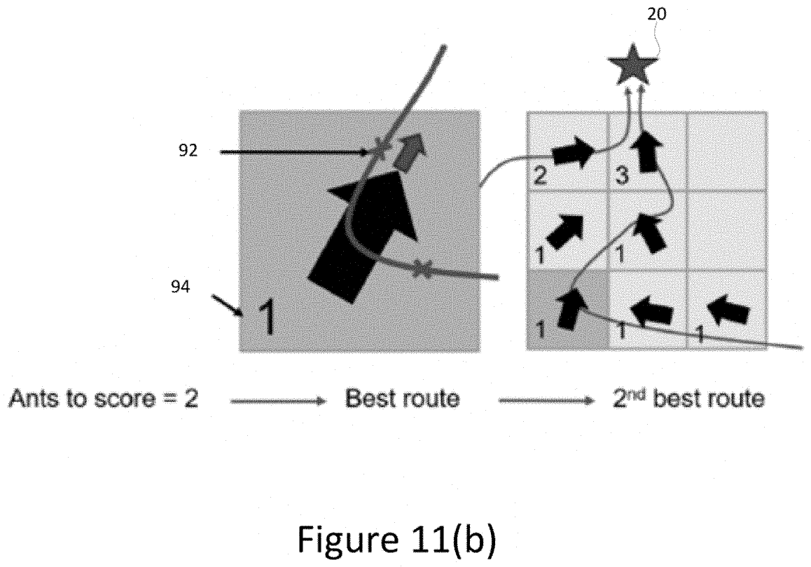

Referring to FIGS. 11(a)-11(b), an aspect of a method of determining a path from a recorded routes is shown.

As described with reference to, for example, FIG. 7, the route finding methods described herein optionally consider multiple generations of route finding, where a route that converges across generations is determined. The paths within each generation are determined based, at least partially, on the routes found within previous generations. A number of the highest scoring routes are recorded; these recorded routes are considered within subsequent generations where agents are “attracted” to these routes—e.g. they are likely to change direction to follow a previously laid route.

In some embodiments, relatively low scoring routes are also considered, where agents also consider these routes, e.g. they may be likely to change direction in order to not follow a relatively low scoring route.

Referring to FIG. 11(a), there is shown a method of considering the effect of recorded routes comprising recording the locations through which agents travelled during the determination of those recorded routes. The agent 102 is affected by the recorded locations, where the agent 102 is more likely to pass through a location if it is associated with a recorded route. The effect of the recorded locations depends on, for example, the number of recorded routes travelling through the location, the scores associated with these recorded routes, and how many generations it has been since these routes were recorded.

Referring to FIG. 11(b), there is shown an alternate method of considering the effect of recorded routes. This method comprises recording routes by recording headings 92 related to locations. The headings depend upon, for example, the number of recorded routes travelling through the location, the headings associated with these recorded routes, the scores associated with these recorded routes, and how many generations it has been since these routes were recorded. The heading is preferably a vector summation of each heading recorded for a given point, or area. Optionally the summation comprises weighting each recorded heading by a measure of the relative scores of the routes related to that heading.

By recording headings, the effect of a recorded route upon an agent is determinable simply by consideration of the current location of an agent and not the surrounding locations. This reduces the required computational load and also reduces the amount of data that needs to be recorded.

In some embodiments, headings are only recorded in locations associated with recorded routes. In regions that no routes are recorded, no headings are recorded.

This forms a sparse grid, where there is recording of information only in locations traversed by recorded routes. Such a method therefore reduces the computational load associated with storage of an entirely populated grid and is compatible with non-grid based movement.

Within the grid based method of FIG. 11(a), each grid location is associated with an effect which encourages the agent 102 to travel through that grid location. In practice, a grid location with a high number (or, in other embodiments, a low rank) attracts an agent, so that the agent is likely to travel through that grid location.

Within the heading based method of FIG. 11(b), headings affect the direction in which an agent travels. This does not require strict adherence to a grid system, as the heading does not relate directly to the agent travelling into an adjacent cell.

Each agent moves in a direction, and with a speed, dependent upon the properties of the agent and the effect of previously recorded routes. After each time step, the position of an agent is determined based upon the position before the time step and the speed and heading used for the time step. Within this determination there is no requirement for an agent to move from, to, or between specific nodes on a grid. The agent may then determine, with reference to each layer of the simulation, whether the current position is possible. As examples, the obstacle layer may be used to determine whether any obstacles impede progress and the bathymetry layer may be used to determine whether at the eventual position the water is sufficiently deep.

Also shown within FIG. 11(b) is a method of determining the effect of previously recorded routes.

One method of determining this effect is that higher scoring routes have a greater effect on the agents of subsequent generations.

In some embodiments, the magnitude of the effect reduces with each generation, so that a recorded route from the first generation has a large effect on the second generation and a smaller effect on the third generation.

Referring to FIG. 11(b), there is shown a method of route recording where the magnitude of the effect optionally does not change with generations. Instead, a recorded route has an effect on agents for a predetermined number of generations 94. This number of generations 94 corresponds to the relative score associated with the route. In this example, the highest scoring route is recorded and has an effect for two generations and the second highest scoring route is recorded and has an effect for one generation. Where two recorded routes travel in substantially the same direction, the number of generations is, optionally, summed, so that in this example, there is an effect for three generations.

In some embodiments, the recorded routes, and/or the related recorded headings, diffuse. After each generation, locations neighbouring recorded locations are associated with an effect, in essence they behave as recorded locations. The magnitude of this effect is preferably reduced as compared to the original recorded location.

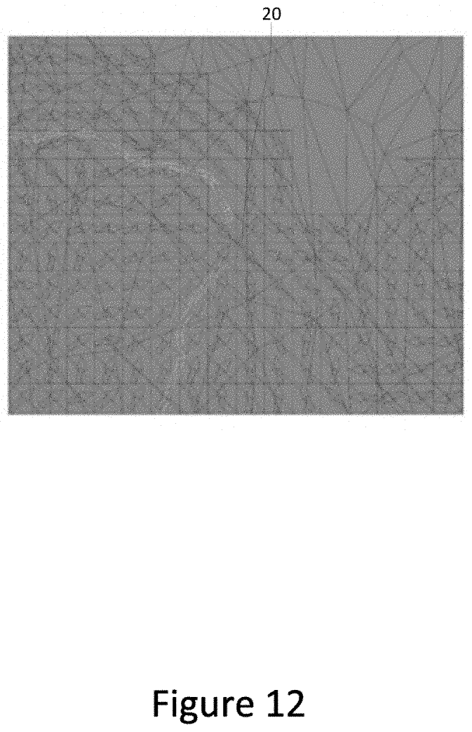

Referring to FIG. 12, the heading based method of FIG. 11(b) is shown implemented on a larger scale than that shown in FIG. 11(b).

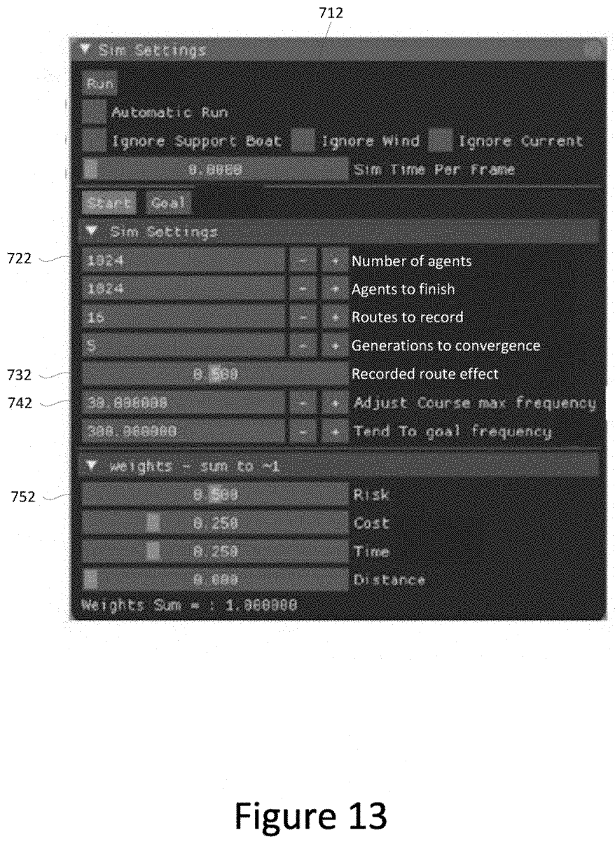

Referring to FIG. 13, there is shown a method of populating simulation data.

Simulation data comprises: environmental data, agent data, and scoring data.

The effect of environmental conditions, such as wind, is alterable using an environmental input 712. The environmental input 712 optionally comprises at least one of: a determination of whether one or more environmental effects should be considered; information related to properties of environmental effects; such as a wind speed.

Agent data, such as the number of agents to initialise 722, the number of routes to record, and the number of generations to convergence are selected. A simulation using more agents may achieve a higher scoring route, but may take a longer time to achieve this answer. These options are, in some embodiments, chosen based upon the scenario, e.g. based upon the time available.

Features of the scoring metric, for example the weighting of a risk component score 752 is selectable. In some embodiments, minimum scores, or minimum relative scores, are also selectable.

Variables related to the behaviour of agents, such as the effect of recorded routes 732 upon these agents, and the frequency with which agents adjust their heading 742 are also selectable.

In this embodiment, the behaviour of agents is dependent upon a pseudo-random algorithm, which has as an input a random seed. User selectable variables, such as the frequency with which agents adjust their heading 742 have an effect upon the eventual behaviour, but there is also a random element. As an example, in some embodiments the user is able to set a range; a user may be able to suggest that agents adjust their heading every 5 to 10 timesteps, where the heading adjustment frequency for each agent is randomly chosen within this.

The user is able to set a value which affects a probability density function. There may, for example, be a normal distribution for which the user is able to set the mean and/or variance. This enables the user to modify the agent data in consideration of the current situation, while also initialising agents with properties different from those selected by the user. In some embodiments, there is a feedback mechanism to guide user choice. As an example: when a user selects a heading adjustment frequency of 10 timesteps a normal distribution with a mean of 10 timesteps is generated and the heading adjustment frequency of agents is determined using this normal distribution. If a number of recorded routes are related to agents with a heading adjustment frequency in excess of 15 timesteps, it may be suggested to the user that the selected value be altered.

The random seed is useable not only to determine the behaviours of each agent, but also to implement the behaviours. A pseudorandom number may be determined, using a generator, for each situation, which is used to inform the agent's actions. As an example, an agent may have a certain likelihood of responding to a recorded route, say 30%, when this agent is adjacent to a recorded route a pseudorandom number may be determined based upon the random seed of the agent, if this number is greater than 0.3, the agent may turn towards the route (where the amount of turning may also depend upon agent behaviour and another generated pseudorandom number).

Determining behaviours dependent upon a random seed allows a route to be determine based solely upon the same random seed. This enables the recording of routes by recording only the random seed, as opposed to recording the coordinates of the routes. The use of the random seed then enables reduction of the amount of information which must be recorded. Further to this, even the random seed need not be recorded as it is determinable from the user selected simulation settings.

This random seed is useable for the reinitialisation process described with reference to FIGS. 7-9. The reinitialised agent 108 behaves according to the properties of the third agent 106 for a portion of the route, after which the reinitialised agent 108 behaves according to the properties of the second agent 104. Here, there is only required the recording of the random seeds of the second agent 104 and the third agent 106 and the period for which the properties of the third agent 106 are to be used.

In some embodiments, multiple random seeds are used to define a plurality of properties. Even in cases where such a plurality of seeds are used, and where multiple agents are reinitialised, the amount of recording is normally substantially reduced as compared to a method which records routes via recording co-ordinates.

The behaviour of agents is dependent upon capabilities of the agents, where these capabilities are determined by the capabilities of the object 100. As examples, capabilities may refer to, for example, a maximum speed, a turning radius, a strength and/or impact capability, and/or a weight; a weight would be used, for example, in the determination of the effect of wind. By defining a capability range and ensuring that the behaviour of agents conforms to the capabilities it is ensured that the object 100 is capable of following the determined route.

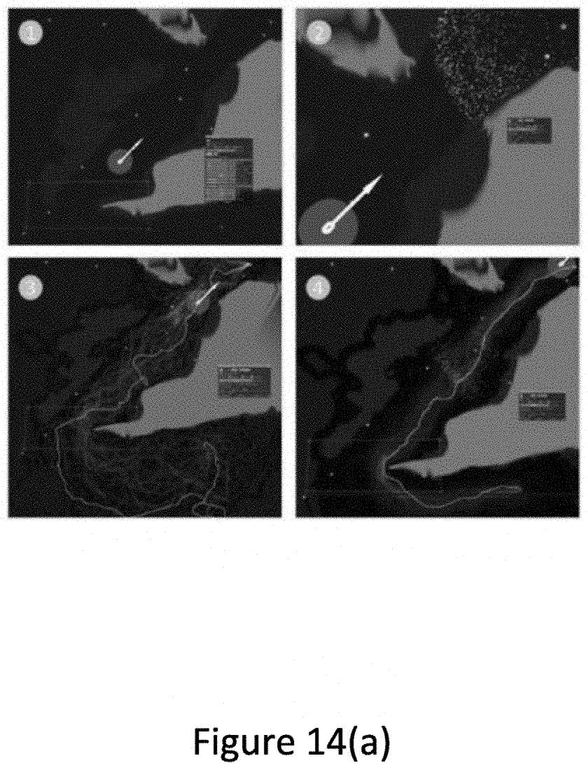

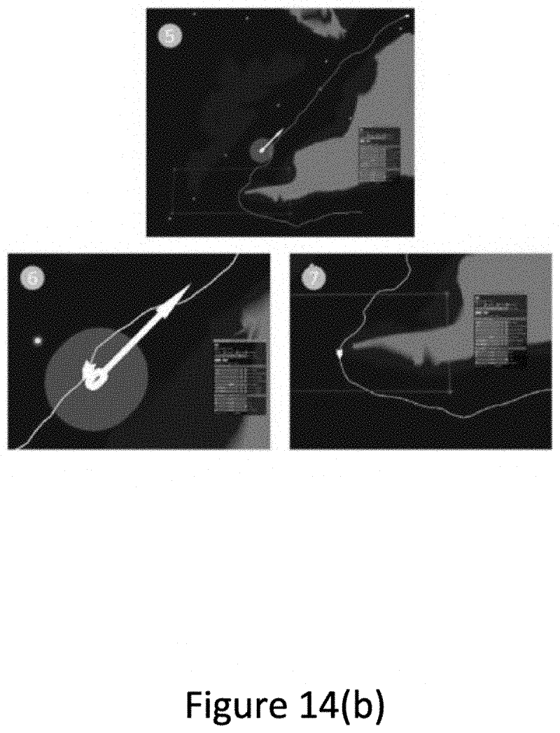

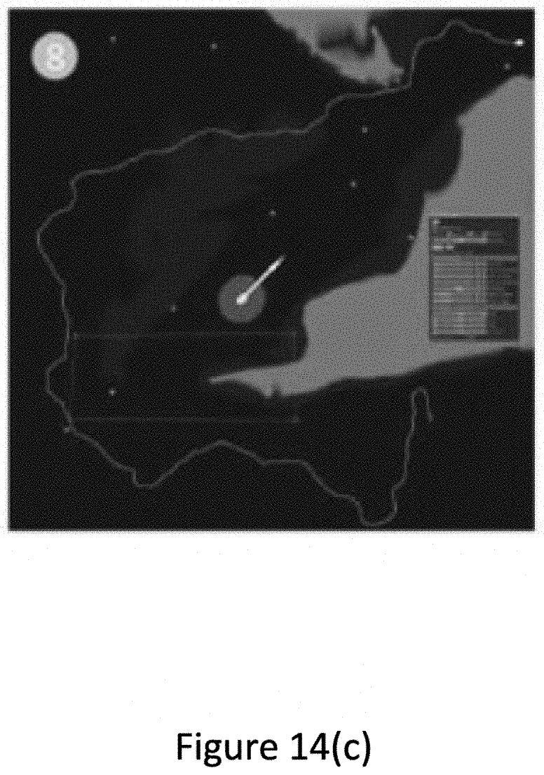

Referring to FIGS. 14(a)-14(c), there is shown a variety of routes selected using different scoring metrics.

FIGS. 14(a) and 14(b) show a route determined with a scoring metric prioritising a low time; FIG. 14(c) shows a route determined within the same environment a scoring metric prioritising a low risk.

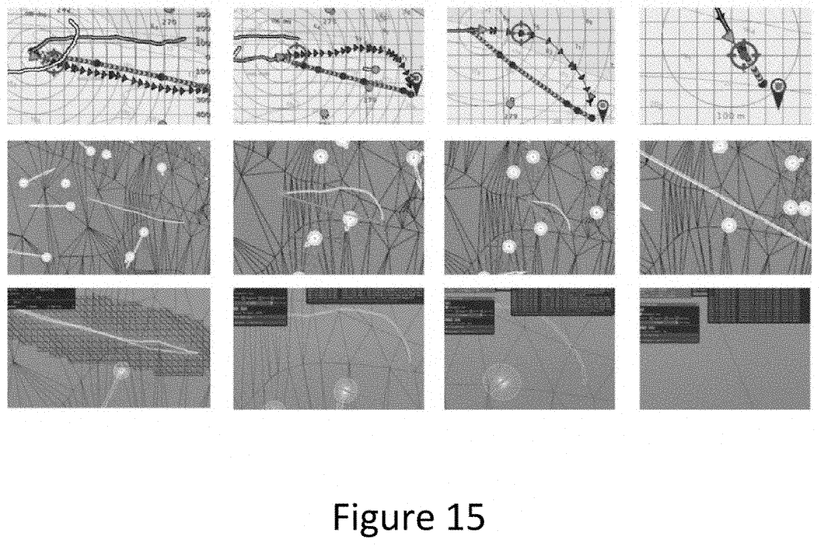

FIG. 15 shows the operation of the sub-route planning module 134.

In embodiments where the sub-route planning module 134 is used, it is arranged to determine sub-routes within a larger determined route. The route planning module 132 is arranged to determine a route between the starting point 10 and the destination 20. This route optionally contains a number of waypoints.

The sub-route planning module 134 is arranged to determine, using similar method to the route finding module within a smaller considered environment, deviations from this route. The sub-route planning module 134 takes into account changing factors, such as the behaviour of the obstacle 30, so that the route may be altered where necessary to avoid a collision, or to manoeuvre around an area of unacceptable risk. The sub-route planning module 134 determines sub-routes so that the diverted route intersects the route selected by the route finding module.

In practice, a route is determined by the route finding module 132 between the starting point 10 and the destination 20. A number of waypoints are determined within this route. At each waypoint, the sub-route finding module 134 determines whether any information is available that alters the optimal route. The sub-route finding module 134 then determines a new optimal route between two or more waypoints dependent upon the new factors. The original route is used once a waypoint upon this route is reached. This diversion based upon the sub-route finding module 134 may repeat numerous times within any journey.

Here it is shown how a route may diverge from the route planned by the route planning module 132 to avoid the obstacle 30 and/or the undesirable zone 40.

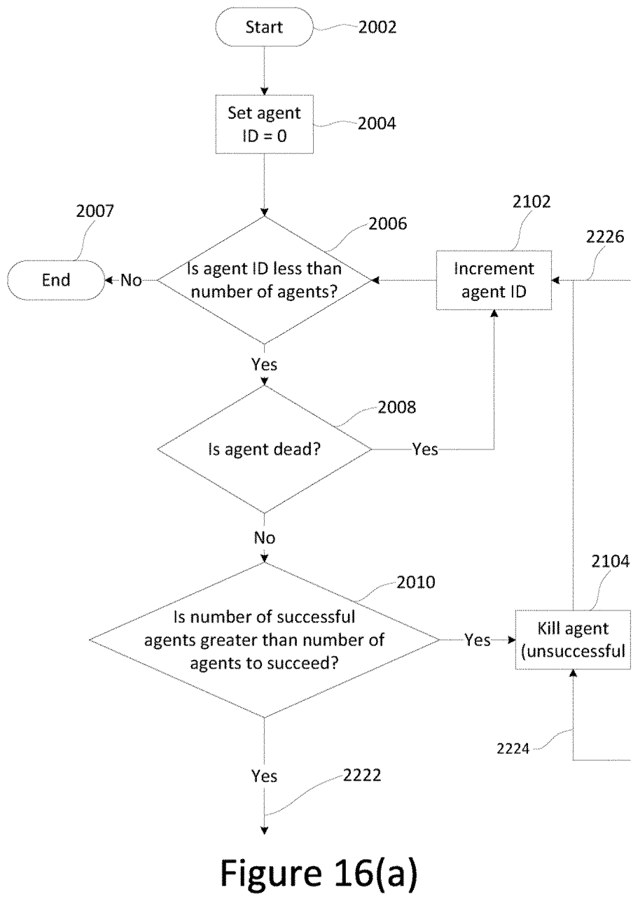

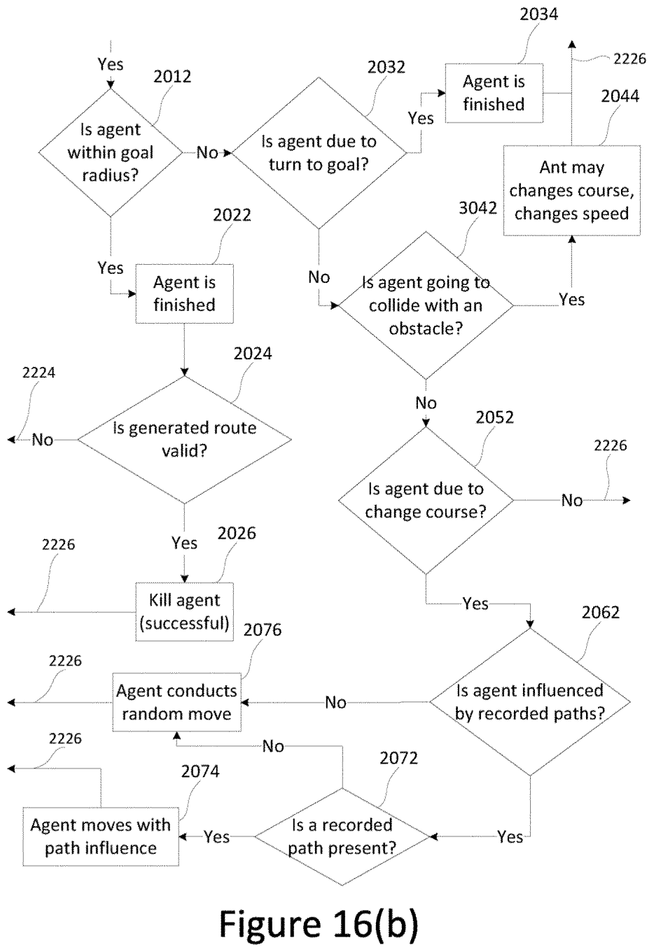

Referring to FIGS. 16(a) and 16(b), there is shown a detailed implementation of aspects of the methods described herein.

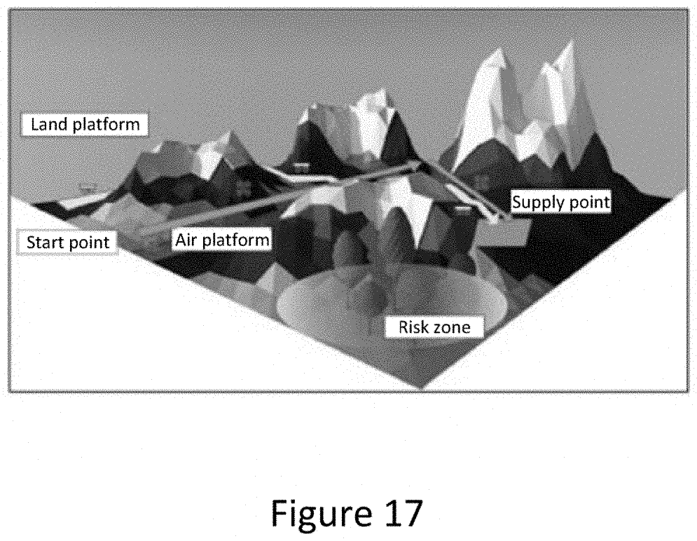

Referring to FIG. 17, there is shown a variety of uses of the methods described herein.

The determination of routes may, for example, be useful for land, air, or maritime platforms in a variety of situations. Here the obstacles primarily comprise mountains, in a maritime environment obstacles may comprise other boats and/or shallow areas, in the air obstacles may comprise birds and/or planes.

The methods described above are, in variable embodiments, used in various combinations. As examples, aspects related to recording routes, aspects related to reinitialising agents, and aspects related to initialising agents based upon random seeds would be advantageous in isolation or in any combination.

It will be understood that the present invention has been described above purely by way of example, and modifications of detail can be made within the scope of the invention.

Reference numerals appearing in the claims are by way of illustration only and shall have no limiting effect on the scope of the claims.

1. A computer-implemented method of determining a route to a destination, the method comprising:
initialising a plurality of agents, each of which agents is arranged to find a respective path towards the destination by making a series of route decisions based on behaviour parameters, the behaviour parameters being different for different agents;
modifying the plurality of agents by:
scoring the paths found by the plurality of agents,
comparing the paths found by the plurality of agents to a threshold score,
determining a first agent of the plurality of agents, the first agent having found a path with a score on one side of the threshold score,
determining a second agent of the plurality of agents, the second agent having found a path with a score on the other side of the threshold score,
adding a third agent to the plurality of agents, the third agent being arranged to find a path towards the destination based on behaviour parameters the same as the behaviour parameters of the first agent and initially being located on the path of the second agent, and
optionally removing the first agent from the plurality of agents; and
optionally repeating the modifying until the path found by at least one of the agents of the plurality of agents reaches the destination.

2. The method of claim 1, wherein the scoring is based upon at least one of: time taken to travel along the path, risk associated with travelling along the path and cost of travelling along the path.

3. The method of claim 1, wherein the threshold score is based upon at least one of: a best scoring path; the relative scores of each path; a user-selected threshold score; a maximum allowable time; a maximum allowable risk;
and a maximum allowable cost.

4. The method of claim 1, wherein the second agent is initially determined by at least one of: random selection among each agent having found a path with a score on the other side of the threshold score; selecting the agent related to a best scoring path; weighted random selection among the plurality of agents according to the relative scores of the path related to each agent and/or wherein the location on the path of the second agent at which the third agent is initially located is dependent upon at least one of: the distribution of scores of the paths of one or more agents within the plurality of agents; the threshold score; a user selection; and a pseudorandom number.

5. The method of claim 1, wherein -comparing the paths found by the plurality of agents to a threshold score comprises: comparing the paths found by the plurality of agents to a plurality of threshold scores; and determining a first agent of the plurality of agents having found a path with a score on one side of every score threshold.

6. The method of claim 1, wherein repeating the modifying until the path found by at least one of the agents of the plurality of agents reaches the destination comprises repetitively modifying the plurality of agents until a plurality of agents reaches the destination, preferably wherein the number of agents is dependent upon the relative scores of at least two agents.

7. The method of claim 1, wherein the behaviour parameters of each agent are determined based upon a random seed.

8. A computer-implemented method of determining a route to a destination, comprising:
initialising a plurality of agents; which plurality of agents are each arranged to find a respective path towards the destination by making a series of decisions based on behaviour parameters, the behaviour parameters being different for different agents;
wherein the behaviour parameters of each agent are determined based upon a random seed; and
storing the random seed associated with each agent.

9. The method of claim 8, further comprising recording a determined route based solely upon the random seed.

10. The method of claim 8, wherein the random seed is generated based upon a user selection and/or wherein the behaviour parameters of each agent are determined based upon a plurality of random seeds.

11. (canceled)

12. The method of claim 1, wherein the behaviour parameters of each agent relate to at least one of: a frequency of changing direction; a probability of turning in a given direction; a probability of turning towards the destination.

13. The method of claim 1, wherein the behaviour parameters are determined using a probability density function, preferably wherein the probability density function is a Gaussian distribution and/or wherein the behaviour parameters are determined based upon a user input, preferably wherein the user input is at least one of: a capability range, a capability threshold, a preferred behaviour.

14. The method of claim 1, further comprising:
scoring the paths determined by each agent;
comparing the paths found by each of the plurality of agents to a threshold score;
recording a feature of the paths scoring on one side of the threshold; and
wherein the plurality of agents are each arranged to find a respective path towards the destination by making a series of route decisions based on recorded features related to the paths of prior initialised agents.

15. A computer-implemented method of determining a route to a destination, comprising:
repetitively initialising a plurality of agents, which plurality of agents are each arranged to find a respective path towards the destination by making a series of route decisions based on behaviour parameters, the behaviour parameters being different for different agents;
scoring the paths determined by each agent;
comparing the paths found by each of the plurality of agents to a threshold score;
recording a feature of the paths scoring on one side of the threshold; wherein the plurality of agents are each arranged to find a respective path towards the destination by making a series of route decisions based on recorded features related to the paths of prior initialised agents; and
optionally, wherein the agents are repetitively initialised until at least one of the agent reaches the destination.

16. The method of claim 15, wherein the recorded feature is a heading and/or wherein the recorded feature is a summed vector of the recorded feature of a plurality of paths scoring above the threshold score, preferably wherein the summed vector is weighted based upon the relative scores of the plurality of paths.

17. The method of claim 15, wherein the recorded feature is recorded for a predetermined number of reinitialisations, preferably wherein the recorded feature is not altered between generations and/or wherein the predetermined number of reinitialisations depends on the score of the related path.

18. The method of claim 15, wherein the area over which the plurality of agents is affected by the recorded feature changes between generations, preferably wherein the change is an increase, more preferably wherein the effect of the recorded feature decreases as the area affected increases.

19. The method of claim 1, wherein the agents are arranged to determine a route between two locations in an environment; wherein the environment comprises a plurality layers, each layer relating to a different feature.

20. (canceled)

21. The method of claim 19, wherein the layers include at least one of: an agent layer, a static obstacle layer; a dynamic obstacle layer, a natural conditions layer, a user input layer, a bathymetry layer and/or wherein at least one layer relates to at least one of: a frequency of data being updated; a data source; and a measure of the reliability of data, preferably wherein the layers are of different sizes.

22. (canceled)

23. The method of claim 1, further comprising:
determining an improvement related to modifying a portion of the determined route;
modifying a portion of the determined route using the method of any one of the preceding claims; and
optionally, determining waypoints within the determined route; wherein modifying a portion of the determined route comprises modifying a portion of the determined route between two waypoints.

24-25 (canceled)
